(19) United States
(12) Patent Application Publication
(10) Pub. No.: US 2008/0307486 A1
(43) Pub. Date: Dec. 11, 2008

(54) ENTITY BASED ACCESS MANAGEMENT

(75) Inventors: Carl Melvin Ellison, Seattle, WA (US); Paul J. Leach, Seattle, WA (US); Butler Wright Lampson, Cambridge, MA (US); Melissa W. Dunn, Woodinville, WA (US); Ravindra Nath Pandya, Clyde Hill, WA (US); Charles William Kaufman, Sammamish, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/761,170

(22) Filed: Jun. 11, 2007

(51) Int. Cl. G06F 17/00; H04L 9/32

(52) U.S. Cl. 726/1; 726/2

(57) ABSTRACT

The subject disclosure pertains to systems and methods that facilitate entity-based for access management. Typically, access to one or more resources is managed based upon identifiers assigned to entities. Groups of identifiers can be assigned to access rights. An authority component can manage an exclusion group that excludes an entity, regardless of the identifier utilized by the entity. Access control components can utilize exclusion groups in access policies to define access rights to a resource.

### CROSS-REFERENCE

This application is related to U.S. Nonprovisional application Ser. No. 11/756,393 entitled “ACCESS CONTROL NEGATION USING NEGATIVE GROUPS,” filed on May 31, 2007. The entirety of which is incorporated by reference herein.

### BACKGROUND

Computers and computer networks have become ubiquitous in today's society. Virtually every business utilizes computers and computer networks for tasks such as managing inventory, billing, document preparation, product design and/or production and the like. Similarly, educational institutions and nonprofit organizations utilize computers for research, word-processing and other processes. Individuals of all occupations and lifestyles utilize computers and the Internet to manage bank accounts, prepare of tax returns, view product information, sell and purchase products, download audio and video files, take classes, research topics, and find directions among other things. Further, usage of computers and computer networks will continue to flourish as addition information becomes available.

Improvements in interconnectivity and accessibility have also increased utility of computers and computer networks. Users can access resources remotely to retrieve and generate email, edit and/or create documents and perform similar tasks. Mobile devices such as laptops, smartphones, PDAs or a variety of other devices allow users to access the Internet and other networks. The growth of wireless networks has also increased accessibility and therefore utility of computer networks. Many coffee shops, libraries and the like now provide wireless access to customers.

Security and privacy have become critical issues with the increase in collection and accessibility of information. Data can include information crucial to organizations, such as trade secrets, employee information, inventory, customer lists and the like. Data can also include private individual information (e.g., bank records, credit information, and health information). Collection of such personal information has caused concern regarding loss of individual privacy as well as the possibility of identity theft. A key issue is allowing access to individuals or groups of individuals with proper authority, while denying access to any others.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the provided subject matter concerns access management for resources such as computer networks, data files and the like. Many computing environments include multiple authorities capable of issuing identifiers (e.g., user IDs or names) to individuals or entities. Typically, entities can obtain multiple identifiers, at least one from each authority. However, access management is based upon grant or denial of access rights to a particular identifier associated with an entity, rather than an entity itself, while security policy is formulated by human beings with respect to entities, rather than identifiers. This leaves open the possibility that an entity will circumvent the access management policy by utilizing a second identifier.

The systems and methods described herein are directed to entity-based access management utilizing exclusion groups. Groups can consist of sets or lists of identifiers and are used to simplify access policy definition. For example, if all members of a group are to be assigned a particular access right, the right for the group can be specified without requiring individual specification of rights for each member. An exclusion group can be defined such that a particular entity is excluded from the exclusion group regardless of the identifier used by the entity. Exclusion groups can be formed by selecting a base group and excluding an identifier associated with the entity to be excluded. The authority that issues the group and entity identifier should issue a single identifier to an entity. This identifier should be unique with respect to the authority and should be consistent over time.

Effectiveness of an exclusion group can be affected based upon selection of a base group and issuing authority. The probability of correct exclusion of an entity can depend upon the methods used by the authority to determine entity identity (e.g. facial images, fingerprints, voice recognition and the like). In addition, an exclusion group is limited by the base group used to construct the exclusion group. Exclusion groups can be used in various access control systems, such as access control lists and certificate based access control.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that facilitates access management utilizing negative groups in accordance with an aspect of the subject matter disclosed herein.

FIG. 2 is a block diagram of an access management system utilizing negative groups in accordance with an aspect of the subject matter disclosed herein.

FIG. 3 is a block diagram of an authority component that provides for exclusion groups for use in access management in accordance with an aspect of the subject matter disclosed herein.

FIG. 4 is a block diagram of an access management system that utilizes exclusion groups with access control lists in accordance with an aspect of the subject matter disclosed herein.

FIG. 5 is a block diagram of an access management system that utilizes exclusion groups with certificate based access management in accordance with an aspect of the subject matter disclosed herein.

FIG. 6 illustrates an exemplary methodology for managing access utilizing exclusion groups in accordance with an aspect of the subject matter disclosed herein.

FIG. 7 illustrates an exemplary methodology for determining membership in an exclusion group in accordance with an aspect of the subject matter disclosed herein.

FIG. 8 illustrates an exemplary methodology for setting access policy utilizing an exclusion group in accordance with an aspect of the subject matter disclosed herein.

FIG. 9 is a schematic block diagram illustrating a suitable operating environment.

FIG. 10 is a schematic block diagram of a sample-computing environment

### DETAILED DESCRIPTION

The various aspects of the subject matter disclosed herein are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The word “exemplary” is used herein to mean serving as an example, instance, or illustration. The subject matter disclosed herein is not limited by such examples. In addition, any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Access to various resources is generally controlled using identifiers issued to entities by an authority or authorities. As used herein, an entity can be an individual human being, an organization, a machine or other being. An identifier is a login, username, alphanumeric code or any other data that identifies a particular entity. Access policies typically utilize identifiers to describe entities that are to be granted or denied access to a particular resource. Access control algorithms refer to identifiers but human beings creating the security policy that the access control algorithm is supposed to enforce think in terms of entities.

Groups of entity identifiers can be utilized to facilitate access control. A group conceptually consists of a set of entities. However, groups are typically defined based upon identifiers associated with entities, rather than the entities themselves. Consequently, a group is in fact made up of a set of identifiers, not actual entities or individuals. Entities may have multiple identifiers issued by different authorities and included in disparate groups with varying access rights. For example, an individual may have a username associated with a personal email account and a separate user name for a work email account.

Groups can be used to reduce the number of entries in an access policy. When all members of the group should receive the same access, one entry specifying access for the group takes the place of the set of identifiers, one per group member, which would otherwise be required. Furthermore, a defined group can change its membership without requiring the access policies that refer to that group to be modified. For example, a corporation may define individual groups for separate departments within the organization, each group consisting of employees within that department. Access to certain computer networks within the organization may be limited based upon department. For instance, only employees in the accounting department or management department may have access rights to accounting information. Access rights can be updated by modifying the group definitions, rather than requiring update of one or more access policies. As employees are hired or leave the organization, the employee identifiers can be added or deleted from the appropriate department groups.

Access can be managed using positive grants of access rights, where an entity or group of entities is specifically allowed access to a resource. Access can also be managed via negation or specific denial of access to a particular entity or group. There may be many situations in which it is useful to deny access to a particular entity, rather than explicitly granting access to a set of entities. For example, an email announcing a surprise birthday party may be sent to everyone except the individual to be surprised. When specifying access rights, it may be easier to deny rights to the single individual than to specify a positive access right for every other group member.

Access control based upon entities rather than identifiers is complicated by the fact that entities are not limited to a single identifier. A single entity may have multiple associated identifiers with differing access rights. For example, a user may have a multiple login identifiers for a system. The problem is even more complex in multi-domain environments where information regarding various identifiers and groups may not be shared between domains. For instance a single individual or entity may have a login in for a computer network, a separate email account (e.g., a hotmail account, Gmail account and the like) and one or more identifiers used for banking, online bill paying, online shopping and the like. Since these identities may not be linked, ensuring that an entity is denied access to a particular resource may be difficult without complete information as to the various identifiers associated with the entity.

One deceptively simple solution to entity-based management would be to have a single authority that issues a single identity or identifier to each entity or individual. A one-to-one correspondence between digital identifiers and entities would allow for easy denial of access to a particular individual. However, it is politically untenable to establish a global authority that issues a global identifier to each entity. The likelihood of global acceptance of a single authority is extremely small. Moreover, requiring use of a single identifier for all interactions and transactions raises significant privacy concerns.

Achieving a proper level of identity assuredness may also be a problem with a single, global authority. Systems that utilize identifiers may require different levels of assuredness that an identifier correctly identifies an entity. For instance, some users (e.g., financial or governmental institutions) might demand assurance with a probability of error less than 10⁻³⁰, even if the access management system were under attack by a well-funded and very determined adversary. Other systems might require only a reasonable certainty that entities are correctly identified. For example, an access management system that allowed for sharing of photographs among friends may not require as high a probability that entities are correctly identified as an access management system for a classified research project. If each entity were issued a single identifier for global use, that identifier would have to have the highest level of assuredness in order to satisfy all systems that utilize identifiers. Such an identifier would likely be costly to issue and customers would bear the cost of such identity assurance.

Within a limited domain, it may be practical to have a central authority that issues identifiers to entities. For example, many companies or organizations issue badges or usernames to employees of the company. Various levels of assurance of entity identity can be used depending upon the needs of the organization. For a small company, photo identification may be sufficient to distinguish employees and for identity purposes. Larger organizations or organizations with classified information may require fingerprints or other biometrics to identify particular entities.

To achieve entity-based access control, each identifier can be consistent over time and unique to the entity with respect to the issuing authority. In addition, each entity can be restricted to a single identifier. To be consistent, the entity will receive the same identifier from the authority over time. For example, if an employee were to leave the company and return at a later date, the same identifier should be reissued to the employee. Furthermore, no two employees or former employees should be issued the same identifier. Once an identifier is assigned to a particular entity, the identifier cannot be reassigned.

Limited domain identities that are unique with respect to the authority and consistent over time can be used to define groups that exclude an entity regardless of the identifier used by the entity. Such groups are referred to herein as exclusion groups. An exclusion group is defined to ensure that a particular entity is excluded from the group, regardless of the identifier utilized by the entity. An exclusion group goes beyond noting properties that are frequently true by maintaining desired properties concerning creation intent. Multiple authorities can utilize an exclusion group to identify a particular entity. The level assuredness for an exclusion group is dependent upon the way in which the authority identifies entities. Creation of exclusion groups is discussed in detail below.

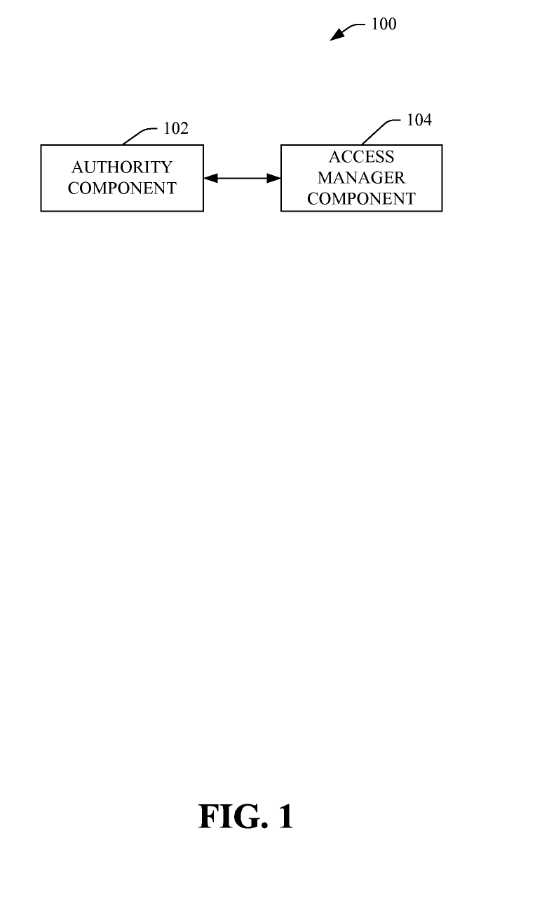

FIG. 1 illustrates a system 100 that facilitates entity-based management of access to resources in accordance with an aspect of the subject matter disclosed herein. Entity-based access management can be facilitated through definition and/or use of exclusion groups. Typically, groups can be represented as lists of their members. For instance, group members can be explicitly listed in a directory. An exclusion group can be defined to include all members of an existing, base group, excluding a particular identity. An access policy can utilize the exclusion group to specify grants or denials of access to a particular resource.

The system 100 includes an authority component 102 that issues identifiers (e.g., a Microsoft Windows Security Identifier (SID)) for entities and groups. A group or entity identifier, such as a SID, can include a globally unique identifier that specifies the authority component that oversees the group or entity. The identifier can also include a local identifier that is unique with respect to the authority component 102 for the entity or group. In the Microsoft Windows operating system, a local machine may serve as the authority for SIDs defined on the local machine, whereas a domain controller may act as the authority for SIDs defined within the corporate domain.

Groups are typically organized within domains. As used herein, a domain is a computer environment, such as a network. Typically, to determine group membership for an identifier, a resource manager (not shown) can obtain a list or report including all groups to which the identifier belongs within the domain. This exhaustive list can be used with the access policy to determine access to resources for an entity identifier. The implication of this exhaustive list is that the entity identifier does not belong to any groups not included on the list. However, the scope of the list is limited to the domain for which it is generated. Furthermore, there is only a negative implication that the entity identifier does not belong to groups not included on the list, rather than a positive statement of exclusion from such groups.

The authority component 102 can also utilize negative groups to manage access to resources. Negative groups can be based upon any other specified group and consist conceptually of all entity identifiers not included within the specified group. This specified group, which serves as a basis for the negative group, is referred to herein as the base group of the negative group. For instance, for a base group ‘G’, the negative group ‘not-G’ would include any entities that are not included within base group ‘G’ or any subgroups that are included in base group ‘G’. In addition, the base group could consist of a single entity identifier. For example, for identifier ‘I’ the group ‘not-identifier I’ would include any other identifier except for entity ‘I’.

The authority component 102 can also define a subtraction group, based upon at least two pre-existing groups. For instance, an identifier is considered a member of subtraction group ‘A-B’, if the identifier is in group ‘A’, but not in group ‘B’. Membership in group ‘A-B’ can be determined by obtaining membership information for group ‘A’ and for group ‘B’.

If an identifier is not a member of group ‘A’, the identifier will not be a member of the subtraction group ‘A-B’. If the identifier is a member of group ‘A’, then the authority component 102 can determine whether the identifier is a member of the negative group ‘not-B’. If the identifier is a member of group ‘A’ and it is also a member of group ‘not-B’, then the identifier is a member of subtraction group ‘A-B.’

Unlike negative groups, subtraction groups have a fixed limit on the number of members within the subtraction group. For instance, subtraction group ‘A-B’ cannot have more members than group ‘A’. Because the subtraction group is limited, it can be expressed as a list of members and may be maintained in a directory or other data store. Alternatively, certificates can be used as evidence of membership in a subtraction group.

An exclusion group can be defined as a particular kind of subtraction group. An exclusion group can be defined using a base group ‘G’, and excluding a particular entity identifier ‘I’, both created by the same authority, such that the authority has a standard practice of issuing only one identifier to an individual entity. Although this does not create a globally unique identifier for an entity, as long as the entity's identifier is unique within G, the exclusion group excludes that entity rather than just one identifier for that entity. An entity identifier is considered a member of exclusion group ‘G-T’ if the entity identifier is included in group ‘G’, but is not the excluded identifier ‘I’.

Specification of an exclusion group by an authority component 102, will exclude not only the particular identifier ‘I’, but also all other identifiers for the entity associated with identifier ‘I,’ as long as the authority component 102 meets certain requirements in issuing identifiers. The authority component 102 should issue a unique identifier to each entity and issue only a single identifier to an entity. Furthermore, the issued identifier issued to an entity should be consistent over time. Because an excluded entity will not able to obtain a different identifier from the authority component 102, the entity will not be able to obtain membership in group ‘G’ other than as identifier ‘I’, which is explicitly omitted from the exclusion group.

The system can also include an access manager component 104 that controls access to one or more resources. The access manager component 104 can direct access based upon an access policy that defines rights granted to particular entity identifiers or group identifiers. The access policy can utilize exclusion groups as provided by the authority component 102 to determine access rights.

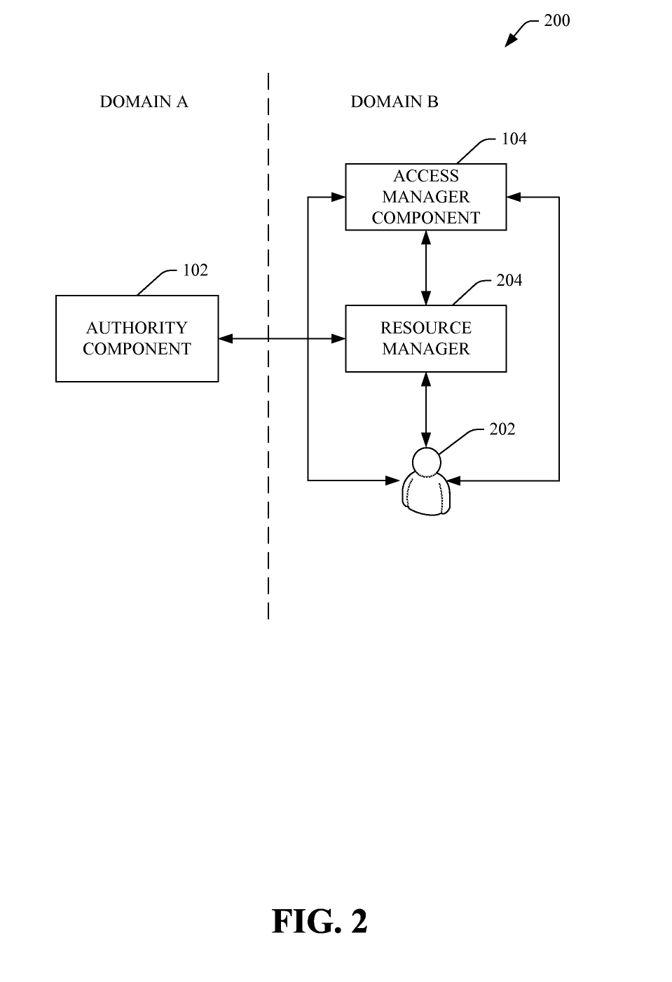

FIG. 2 illustrates an exemplary access management system 200 utilizing exclusion groups. An authority component 102 issues identifiers for entities and groups, including exclusion groups. As described above, each group or entity can be issued a globally unique identifier that specifies the authority component 102 that oversees the group or entity. The issued identifier can also include a local identifier for the entity or group, where the local identifier is unique with respect to the authority component 102. In certain aspects, the authority component 102 can generate statements or records declaring membership of an identifier in one or more groups (e.g., base groups, negative groups, subtraction groups and/or exclusion groups). These statements of group membership can be used in conjunction with access policies to determine access to resources.

The authority component 102 can provide group membership statements, upon request, to the appropriate system component. Depending upon system 200 protocol, group membership information can be provided to the resource manager 204 where the access decision is made, an access manager component 104 or directly to the entity 202. When an entity 202 uses an identifier to request access to a resource, the resource manager 204 can obtain access policy information from an access manager component 104. As a function of the access policy, the resource manager 204 can request group membership information from the authority component 102. The resource manager can determine which authority component 102 to query for group membership statements based upon the group identifier of the relevant group. The authority component 102 and resource manager 204 can communicate across domains as illustrated in FIG. 2, or may be collocated within a domain.

Alternatively, the authority component 102 can provide the statements of group membership in a certificate or digitally signed electronic document directly to the entity 202. Although the entity 202 is illustrated as a human being, the entity can also be a machine, organization or other being. Entities 202 can request certificates at any time prior to use of the certificate. When the entity desires access to a resource, the entity 202 can present the certificate, including group membership information, to the resource manager 204. The resource manager 204 can verify the certificate based upon the digital signature and determine access accordingly. The digital signature can act as proof that the presented certificate has not been modified and was issued by the appropriate authority component 102, ensuring that presented certificate is valid.

In other aspects, an entity can obtain certificates that provide evidence of access rights directly from the access manager component 104. The access manager component 104 can determine appropriate access right certificates to distribute based upon the access policy and group membership information obtained from the authority component 102. Entities can provide certificates of access rights to the resource manager 204 when requesting access to a resource.

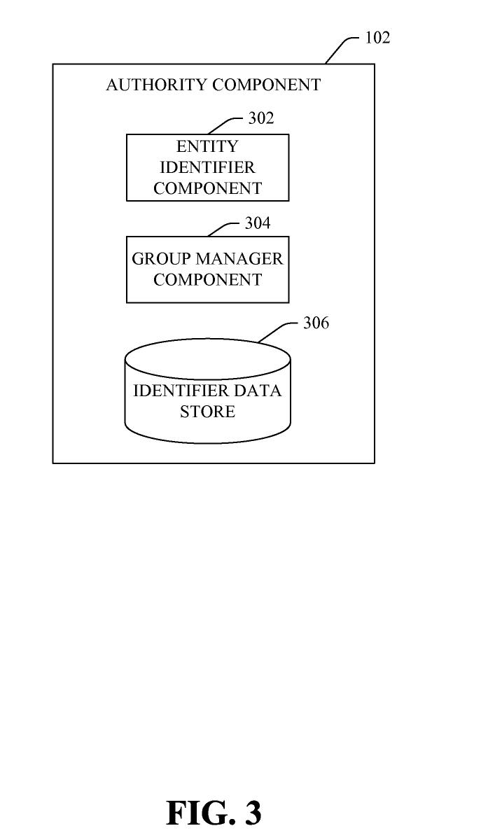

FIG. 3 illustrates an authority component 102 that facilitates access management and provides for exclusion groups in accordance with an aspect of the subject matter disclosed herein. The authority component 102 can include an entity identifier component 302 that identifies an entity and issues a unique identifier for the entity. A group manager component 304 can manage groups composed of combinations of entity and group identifiers. Group manager component can issue a group identifier that uniquely identifies a particular group. As described above, the group and entity identifiers can include a global component that identifies the issuing authority and a local identifier that identifies the specific entity or group with respect to the authority component 102. Group and entity identifiers can be maintained in an identifier data store 306. As used herein, a data store is a collection of data (e.g., a set of files, a database, cache or buffer). A single identifier data store 306 is depicted for simplicity, however any number of data stores can be utilized to manage groups, identifiers and/or entities.

The entity identifier component 302 can assign or issue a unique identifier to an entity, where the identifier remains consistent over time. The entity identifier component 302 can issue an ‘inescapable identifier’. An identifier is inescapable if the entity identified is not capable of obtaining a second identifier. Inescapable identifiers are issued by a single authority; otherwise an individual could obtain an identifier from each authority capable of issuing such identifiers. For instance, an individual discovering that their identifier under a first issuer was denied access to resources could obtain a new identifier from a second issuer and apply for access to resources with the second identifier.

Biometrics are often used to identify human beings for purposes of issuing identifiers. Biometrics can include any measurement or data that describes a human being. Some biometrics may be of limited use, since certain characteristics are easily changed or vary naturally over time. For instance, hair color and length, facial hair and weight can be easily changed.

Entity identifiers can utilize biometrics that do not require cooperation or action on the part of the human being. Some biometrics depend upon individual mannerisms or actions, such as voice or speech patterns and movements such as walking. In certain situations, active participation in identification may not be practical. For example, it may be necessary to identify an unconscious individual transported to a hospital. In such cases, biometrics such as fingerprints, iris scans, Deoxyribonucleic acid (DNA) samples, facial images and the like can be used to identify the individual without requiring active participation of the individual in the identification process.

The characteristics or biometrics used to distinguish among entities can be selected to achieve the correct level of assuredness or probability of correct identification of the individual. For humans, highly specific indicia, such as DNA sequencing and other biometric samples have large entropy and may make it virtually impossible for any other individual to be issued the same identifier. However, the existence identical siblings may be problematic for DNA based biometrics. An entity identifier component 302 can utilize non-DNA biometrics such as iris scans, fingerprints, footprints, palm prints and the like instead. The probability of correct identification can depend upon the size of the population to be distinguished. For a small population of twenty employees of a small company, facial images may be adequate to distinguish one member of the population from all others. When the population is that of the entire world, a characteristic with higher entropy (e.g., DNA, iris scan, etc.) can be utilized.

The group manager component 304 can manage basic or positive groups, negative groups, subtraction groups and/or exclusion groups. Groups managed by the group manager component 304 can be utilized by any number of access policies and may be used by access manger components in different domains. Consequently, a single update to the group can affect access to multiple assets and resources. For instance, the group manager component can manage a “Research Department” group that includes all employees that are members of a research team for an organization. The organization can use multiple access policies to control access to a plurality of computer networks and numerous assets (e.g., documents, records or other data). Access policies can utilize the “Research Department” group to define entities with permission to access certain networks and assets. If an employee joins the research team, the employee may be added to the “Research Department” group and would automatically gain access to assets via access policies that utilize the Research Department group. Similarly, if an employee leaves the company, access to materials can be revoked without modifying ACLs by removing the individual from the Research Department group.

Groups are often represented as a list of their members. Alternatively, statements or records can be used to declare membership of an identifier in a group only when that entity needs that statement in order access a resource. Such statements can be provided, upon request, from the group manager component 304 to resource or resource manager where the access decision is made. Alternatively, the statement can be contained in certificate (a digitally signed electronic document issued by a group authority) that can be presented by the entity with an access request.

Use of statements or certificates to establish membership in a negation group can also improve security and privacy in a multi-domain context. When access is controlled in a single domain, a report listing all groups to which an entity belongs may be acceptable. However, in a multi-domain environment, it is not necessarily desirable to distribute information regarding all groups with which an entity is associated. A statement or certificate can be used to establish that the entity is not a member of a particular base group, without providing any additional information regarding groups within the particular domain. Moreover, statements and certificates can be generated without the exhaustive knowledge required to generate the listing all groups to which the entity belongs. A statement or certificate can be generated based solely upon the group that is of interest.

The identifier data store 306 can maintain identifiers associated with entities and groups as well as identifying information for an entity associated with an identifier. Such information can be used to prevent an entity from obtaining multiple identifiers. For example, if entities are human beings, fingerprint data, iris scan or other biometric data can be maintained and associated with a particular identifier. When new identifiers are requested, information related to existing identifiers can be reviewed to ensure that each entity is issued only a single identifier.

The identifier data store 306 can also maintain information on previous identifiers to ensure that identifiers are issued consistently over time. For instance, if an entity's identifier becomes inactive, such as when an individual resigns from an organization, if the entity returns and requests a new identifier, the same identifier should be issued to the entity. If the identifier is not consistent over time, utility of exclusion groups is reduced since individuals can easily secure different identifiers.

Additionally, the identifier data store 306 can maintain group data for groups over which the authority component 102 has authority. Group data can include the unique group identifier issued to a group. In addition, group data can include a list of group members or other data indicative of group membership.

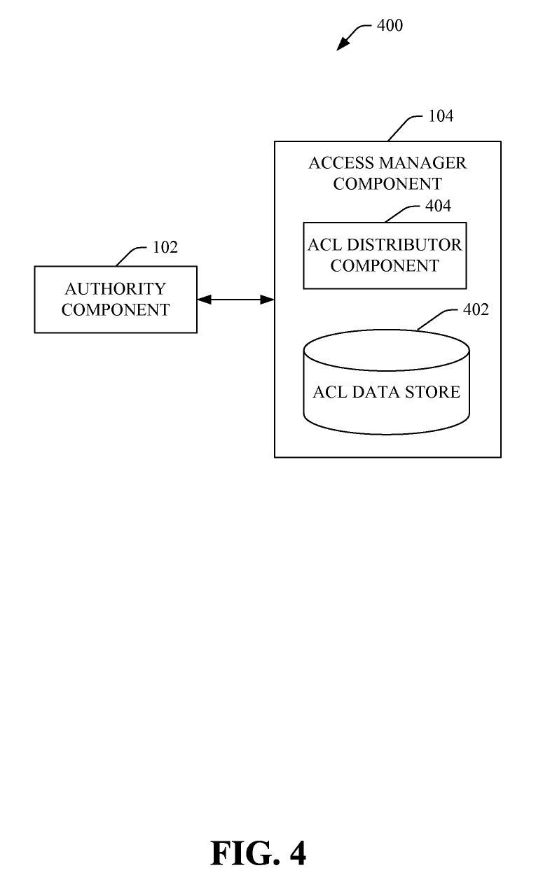

Referring now to FIG. 4, an exemplary access management system 400 that utilizes exclusion groups in conjunction with access control lists is illustrated. The system 400 includes an authority component 102 similar to those described with respect to FIGS. 1 and 3. The system 400 also includes an access manager component 104 that utilizes access control lists (ACLs) to express an access policy.

ACLs are frequently used to manage access to resources including, but not limited to, computer networks, data files, software programs, program features, and the like. ACLs have traditionally been interpreted as sequential or order-dependent lists, in which each entry specifies an entity or group of entities and an action to be taken if the current entity requesting access matches that specification. ACL entries are also referred to as Access Control Entries (ACEs). An entity can be considered to match an entry if it is either the entity referenced in the ACL entry or a member of the group specified in the entry. Actions associated with entries can be positive (e.g., allowing a particular access) or negative (e.g., denying a particular access).

When an entity requests access to a resource, the resource can verify access rights based upon an associated ACL. The typical execution model of an ACL sequentially tests entity identifiers against access control list entries (ACEs). A typical ACE can include multiple fields, depending on how data structures are organized. Each ACE can include a subject that specifies identifier for an entity or group of entities, such as an exclusion group. During the matching process, the identifier for the entity seeking access is compared to the identifier of entity or group specified in the subject of the ACE. Typical ACEs can also include an action, such as ALLOW or DENY. These actions indicate what act is to be performed if the identifier of the entity requesting access matches the subject. For example, an ACE that utilizes an exclusion group as its subject can use a DENY action to deny the excluded entity access to the resource. An ACE can also include permission information, specifying the type of permission to grant the entity if the action allows access. For instance, an entity may be granted read permission for a data file, but not write permission.

The access manager component 104 can include an ACL data store 404 that maintains one or more ACLs that define an access policy. ACLs can be maintained at a central location or locations and resource managers can obtain access information upon request. Alternatively, access manager component 104 can include an ACL distributor component 404 that provides ACLs to one or more distributed locations for use by resource managers. The ACL distributor component 404 can distribute ACLs periodically or as a function of modification of an ACL.

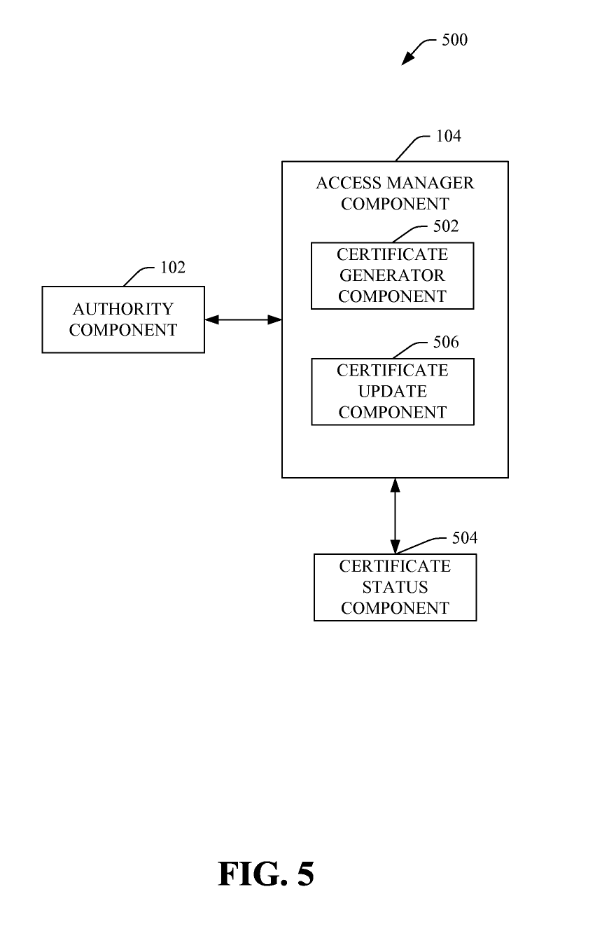

Referring now to FIG. 5, an exemplary access management system 500 that utilizes exclusion groups in conjunction with a set certificates is illustrated. The system 500 includes an authority component 102 similar to those described with respect to FIGS. 1 and 3. The system 500 also includes an access manager component 104 that utilizes access certificates to express an access policy. The access manager component 104 can utilize a set of certificates to indicate access rights for particular identifiers.

The access manager component 104 can include a certificate generator component 502 that can generate certificates containing statements of access rights. The certificate information can specify an identifier and a resource for which the identifier has certain access rights. The certificate information can also include a lifetime or specified period of validity during which the certificate is valid. The lifetime can include a start date and time after which the certificate can be used as evidence of access rights, as well as an expiration date and time, after which the certificate is considered invalid.

The system 500 can also include a certificate status component 504 that can maintain information regarding current state of issued certificates (e.g., valid, revoked and/or expired). The certificate status component 504 can obtain information regarding certificates from a certificate update component 506. The certificate status component 304 can be independent of the access manager component 104 as illustrated, or may be a component of the access manager component 104. The certificate status component 504 can maintain status for certificates issued by one or more access manager components 104, similar to an online certificate status protocol (OCSP).

The certificate status component 504 allows resource managers to confirm the validity and current state of issued certificates. For example, if a certificate is revoked, the certificate update component 506 can notify the certificate status component 504 of the revocation. If an entity attempts to utilize the certificate after revocation, a resource manager can contact the certificate status component 504 to verify certificate validity, and the certificate can be rejected for invalidity.

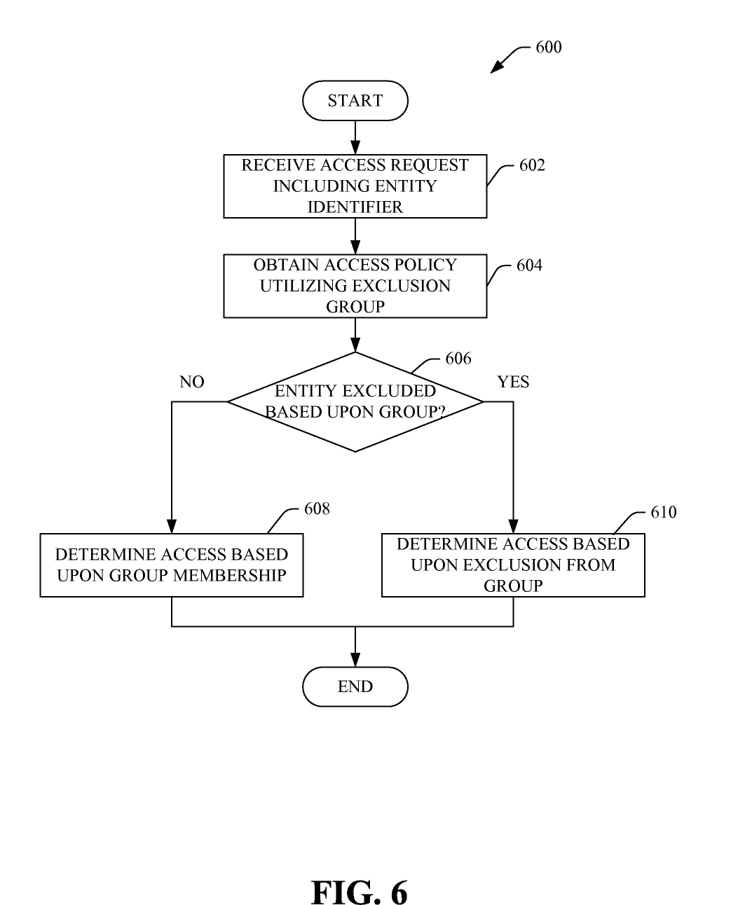

Referring now to FIG. 6, an exemplary methodology 600 for managing access to resources utilizing exclusion groups is illustrated. At 602, a request for access can be received from an entity using an associated identifier. For example, an employee of an organization can attempt to open a file using a particular login ID or username. The request can include an entity identifier (e.g., an SID) that specifies the authority that issued the identifier and uniquely identifies the entity with respect to that authority. The request can be received at a resource manager that determines access to one or more resources.

At 604, access policy information can be obtained for access to the requested resource. The access information contained in an ACL that utilizes an exclusion group to determine access. For example, the exclusion group ‘G-I’ specifies that all members of group ‘G’ except the entity associated with identifier ‘I’ are included in group ‘G-I’. The particular exclusion group can be selected or created to achieve the desired level of assurance of entity identity and to include the appropriate members. The entity associated with the identifier ‘I’ will be excluded as well as any non-members of group ‘G’.

At 606, a determination is made as to whether the entity requesting access is excluded from the exclusion group specified in the ACL for access control. If yes, at 608 access rights are determined based upon exclusion of the entity from the exclusion group. For example, entity with identifier ‘I’ would not be included in the exclusion group ‘G-I’. Consequently, identifier I would not match an ACE with a subject of ‘G-I’ and access rights would be determined accordingly.

If the entity seeking access is a member of the exclusion group, at 610 access rights are determined based upon inclusion of the entity within the exclusion group. For example, if the entity identifier was a member of group ‘G’, other than identifier ‘I’, then the identifier would match an ACE with a subject of ‘G-I’ and the action (e.g., DENY OR ALLOW) associated with that ACE would be utilized.

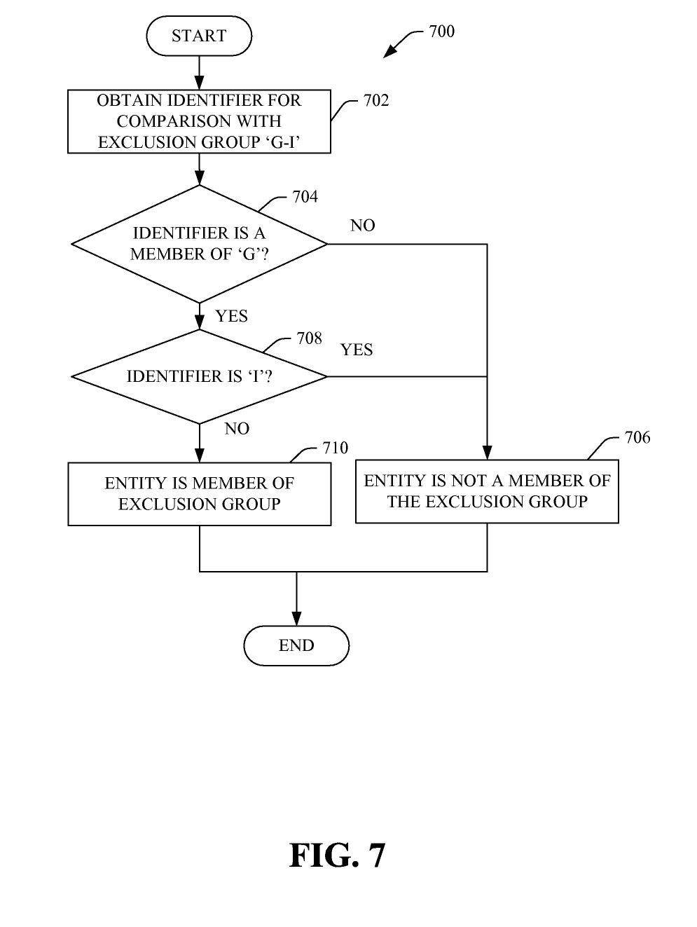

Turning now to FIG. 7, an exemplary methodology 700 for determining membership in an exclusion group is illustrated. At 702, an identifier is obtained for evaluation with respect to a particular exclusion group ‘G-I’. Exclusion groups can be used to deny access to a particular entity, regardless of the identifier used by the entity. An exclusion group ‘G-I’ is defined as a function of a base group ‘G’ and an identifier used for exclusion ‘I’, issued by a single authority.

At 704, a determination is made as to whether the identifier to be evaluated is a member of the base group ‘G’ of exclusion group ‘G-I’. If the identifier is not a member of base group ‘G’, then the identifier is not a member of the exclusion group at 706. While the exclusion group can ensure that a particular entity is not included within the exclusion group, it does not guarantee that all other entities will be included. The base group of the exclusion group limits membership of the exclusion group. Access rights can be determined based upon non-membership of the identifier in the exclusion group.

At 708, a determination is made as to whether the identifier to be evaluated is the identifier to be excluded ‘I’. If yes, then the identifier is not included in the exclusion group at 706. If no, then the identifier is a member of the exclusion group at 710. Access rights for the identifier can be determined based upon inclusion in the exclusion group ‘G-I’.

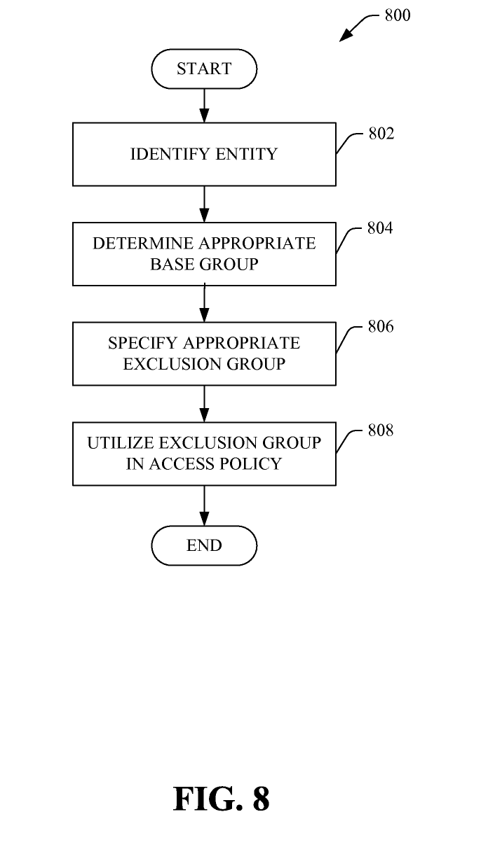

Referring now to FIG. 8, a methodology 800 for creating an exclusion group is illustrated. At 802, an entity to be excluded from a group is selected. Typically, exclusion groups are used to deny access to a resource to a particular individual or entity. Accordingly, the entity to be denied must first be identified.

At 804, a base group is selected to specify the exclusion group. Because any entity identifiers not included in the base group will not be included in the exclusion group, the base group can be chosen to include entities that should be allowed access. Additionally, the base group can be selected to achieve the proper level of assurance that entities are properly identified. For example, biometrics such as iris scans, voice recognition, DNA sequences, fingerprints, palm prints or foot prints, movement analysis, facial imagery, any other identifying characteristics or any combination thereof can be used to associate an entity with a particular identifier. Simpler, less exact methods can be used for where the population is relatively small, or the required level of assurance of identification is relatively low. For highly classified resources or larger populations more exact characteristics can be utilized.

At 806, the particular exclusion group is specified using the selected base group and an identifier associated with the entity to be excluded. The identifier should be issued by the same authority that oversees the base group to ensure that the entity is properly excluded. The identifier should also be unique and consistent over time. The exclusion group can be defined as a subtraction group using the base group and excluding a group that consists of the identifier for the entity to be excluded. The exclusion group can be represented as ‘G-I’.

At 808, the exclusion group can be used in an access policy to ensure appropriate access to one or more resources. The access policy can be implemented using access control lists, in which case one or more ACEs can utilize the exclusion group as a subject. Alternatively, access policy can be implemented as a set of certificates that grant access rights. The exclusion group can be used to determine the certificates necessary express the access policy. Exclusion groups can be used in positive grants of access, but are typically utilized to deny access to a particular entity.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Additionally, it should be noted that one or more components may be combined into a single component providing aggregate functionality or divided into several sub-components. The components may also interact with one or more other components not specifically described herein but known by those of skill in the art.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

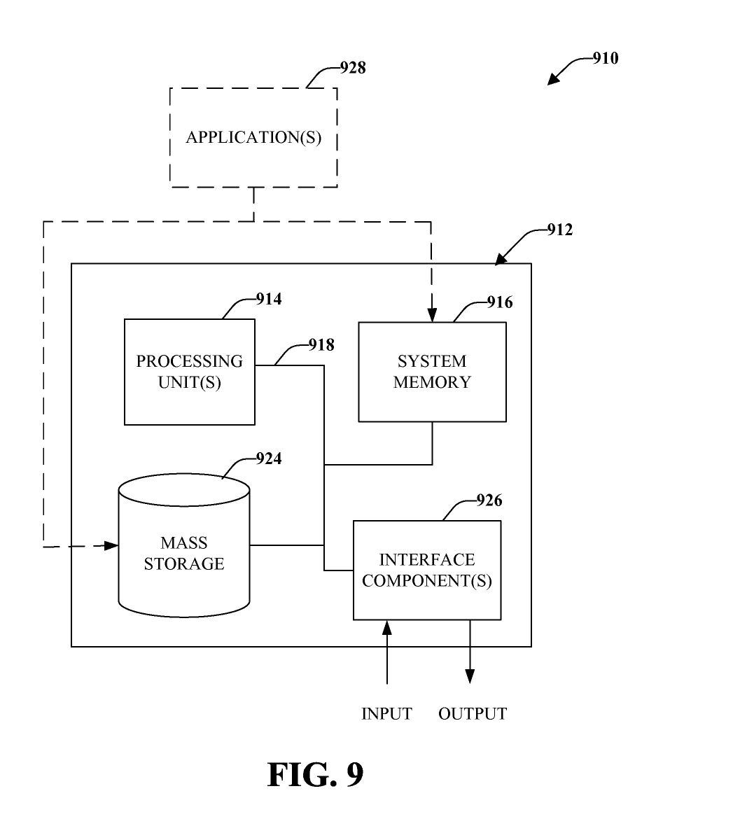

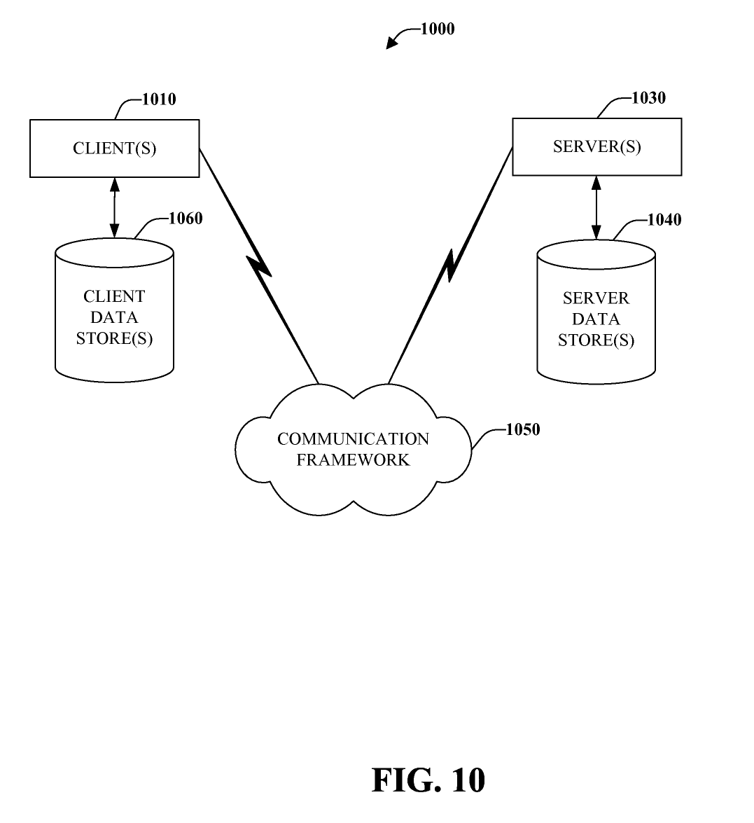

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject matter described herein also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 9, an exemplary environment 910 for implementing various aspects disclosed herein includes a computer 912 (e.g., desktop, laptop, server, hand held, programmable consumer or industrial electronics . . . ). The computer 912 includes a processing unit 914, a system memory 916, and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory or memory stick. In addition, mass storage 924 can include storage media separately or in combination with other storage media.

FIG. 9 provides software application(s) 928 that act as an intermediary between users and/or other computers and the basic computer resources described in suitable operating environment 910. Such software application(s) 928 include one or both of system and application software. System software can include an operating system, which can be stored on mass storage 924, that acts to control and allocate resources of the computer system 912. In particular, operating system can include diagnostic components capable of monitoring and averting failure of a hard disk drive. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., CRT, LCD, plasma . . . ), speakers, printers and other computers, among other things.

FIG. 10 is a schematic block diagram of a sample-computing environment 1000 with which the subject matter can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030. Both the one or more client data store(s) 1060 and the one or more server data store(s) can utilize hard disk drives to maintain data. Both client(s) 1010 and server(s) 1030 can utilize a diagnostic component to prevent failure of data stores and mitigate loss of data.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

What is claimed is:

1. A system that facilitates entity based management of access to resources, comprising:
an authority component that manages an exclusion group that consists of a set of identifiers and excludes an identifier associated with an entity, such that the entity is excluded from the exclusion group without regard to any other identifiers associated with the entity; and
an access control manager that utilizes an access policy to control access to a resource, the access policy utilizes the exclusion group to define an access right.

2. The system of claim 1, the exclusion group includes all members of a base group, except for the excluded identifier.

3. The system of claim 1, further comprising an access control list component that expresses the access policy in an access control list.

4. The system of claim 1, further comprising an access certificate component that generates a set of certificates that express the access policy.

5. The system of claim 1, the excluded identifier includes a global identifier specific to the authority component that issued the identifier.

6. The system of claim 1, the excluded identifier includes a local identifier specific to the entity with respect to the authority component.

7. The system of claim 1, further comprising an entity identifier component that creates the identifier associated with the entity, such that the identifier is unique with respect to the issuing authority component and consistent over time.

8. The system of claim 7, the entity identification component utilizes a biometric to verify the entity.

9. The system of claim 1, further comprising a data store that maintains information related to identifiers issued by the authority component and their associated entities.

10. The system of claim 9, the data store maintains information related previously issued identifiers to ensure that identifiers are consistent over time.

11. The system of claim 1, further comprising a group manager component that issues an identifier for the exclusion group that includes a global identifier specific to the authority component and a local identifier specific to the group with respect to the authority component.

12. A methodology for managing access to at least one resource, comprising:
specifying an exclusion group that includes a set of identifiers and excludes an entity, where the entity is excluded from the exclusion group regardless of identifier utilized by the entity; and
defining access rights to a resource as a function of the exclusion group.

13. The methodology of claim 12, further comprising determining access to the resource as a function of membership in the exclusion group.

14. The methodology of claim 12, the exclusion group consists of a base group of identifiers and excludes an identifier associated with the entity.

15. The methodology of claim 14, further comprising selecting a base group as a function of desired probability of correct entity identification.

16. The methodology of claim 15, the probability is a function of a biometric used in entity identification.

17. The methodology of claim 12, further comprising utilizing the exclusion group in an access control list to express an access policy.

18. The methodology of claim 12, further comprising utilizing the exclusion group to generate a set of certificates that express an access policy.

19. An apparatus that facilitates entity-based access management, comprising:
means for selecting a base group of at least one entity identity, the base group includes an identity associated with an entity to be excluded;
means for specifying an exclusion group that includes members of the base group and excludes the identity associated with the entity, such that the entity is not included in the exclusion group regardless of any other associated identities; and
means for controlling access to a resource as a function of the exclusion group.

20. The apparatus of claim 19, further comprising means for associating the entity with the identity, such that the identity is unique to the entity and consistent over time.
